(19) United States
(12) Patent Application Publication
(10) Pub. No.: US 2024/0161033 A1
(43) Pub. Date: May 16, 2024

(54) SYSTEM AND METHOD FOR UPDATING RESOURCE ASSIGNMENTS

(71) Applicant: Nice Ltd., Ra'anana (IL)

(72) Inventors: Vaibhav CHOBE, Pune (IN); Kanchan VASNANI, Indore (IN)

(73) Assignee: Nice Ltd., Ra'anana (IL)

(21) Appl. No.: 17/987,054

(22) Filed: Nov. 15, 2022

(51) Int. Cl. G06Q 10/06

(52) U.S. Cl. CPC G06Q 10/06312

(57) ABSTRACT

Methods and systems for updating a first assignment of resources include: identifying, by a computing device, based on data describing a first assignment of resources, one or more time periods of the first assignment of resources for which there is an under-assignment of resources; and automatically generating, by the computing device, using data describing one or more auxiliary resources, data describing a second assignment of resources which assigns one or more of the auxiliary resources to the identified one or more time periods.

### FIELD OF THE INVENTION

The present invention relates generally to resource assignments, in particular to updating an assignment of resources to resolve an under-assignment of resources.

### BACKGROUND OF THE INVENTION

Contemporary technology exists to handle the problem of resource assignment, such as computer system resource assignment or generating staffing requirements (e.g. how many agents are needed in each time interval) in various settings such as contact centers.

When resources are limited and a resource becomes unavailable, this can result in an under-assignment of resources. For example, when agents in a contact center request time off work this can result in gaps/understaffing in a schedule. Downtime of computing resources, such as for maintenance, can also result in an under-assignment of resources.

Existing systems typically require human intervention, e.g. a supervisor/manager to invest a lot of time to balance the understaffing situations by manually updating the schedule.

### SUMMARY

Embodiments of the invention include a computer implemented method of updating a first assignment of resources, the method including for example identifying, by a computing device, based on data describing a first assignment of resources, one or more time periods of the first assignment of resources for which there is an under-assignment of resources; and automatically generating, by the computing device, using data describing one or more auxiliary resources, data describing a second assignment of resources which assigns one or more of the auxiliary resources to the identified one or more time periods.

According to some embodiments, the data describing the one or more auxiliary resources includes an indication of an availability of the one or more auxiliary resources for the identified one or more time periods.

According to some embodiments, the data describing the one or more auxiliary resources includes, for at least one of the one or more auxiliary resources, an indication of at least one assignment rule, and wherein the second assignment of resources is automatically generated in accordance with the at least one assignment rule.

According to some embodiments, the data describing one or more auxiliary resources includes, for at least one of the one or more auxiliary resources, an indication of a plurality of assignment rules, and wherein the second assignment of resources is automatically generated in accordance with a maximal number of the plurality of assignment rules.

According to some embodiments: the first assignment of resources is a schedule for one or more workers; the one or more time periods are one or more time periods in the schedule for which there is an understaffing; the data describing the one or more auxiliary resources is data describing one or more available workers who indicated as part of a time-off request an availability outside of a predefined set of work times; and the second assignment of resources is an updated schedule which assigns at least one of the one or more available workers to at least one of the one or more time periods.

According to some embodiments, the availability outside of the predefined set of work times of the one or more available workers is indicated using a graphical user interface associated with an application platform for requesting time off.

According to some embodiments, the method includes distributing, by the computing device, the data describing the second assignment of resources to one or more other computing devices.

Embodiments of the invention may relate to a system for updating a first assignment of resources, the system including: a computing device comprising at least one processor and a memory containing instructions which, when executed by the at least one processor, cause the at least one processor to: identify, based on data describing a first assignment of resources, one or more time periods of the first assignment of resources for which there is an under-assignment of resources; and automatically generate, using data describing one or more auxiliary resources, data describing a second assignment of resources which assigns one or more of the auxiliary resources to the identified one or more time periods.

According to some embodiments, the at least one processor is configured to distribute the data describing the second assignment of resources to one or more other computing devices.

Embodiments of the invention may relate to a computer implemented method for altering an initial resource assignment, the method including: determining, by a computing device, from data describing the initial resource assignment, one or more intervals of the initial resource assignment for which a number of assigned resources is less than a number of resources forecasted to be required for the one or more intervals; and automatically creating, by the computing device, using data describing one or more initially unassigned resources, data describing an altered resource assignment which assigns one or more of the initially unassigned resources to the identified one or more intervals.

In some embodiments, the data describing the one or more initially unassigned resources includes an indication of an availability of the one or more initially unassigned resources for the identified one or more intervals.

In some embodiments, the data describing the one or more initially unassigned resources includes, for at least one of the one or more initially unassigned resources, an indication of at least one assignment criteria, and wherein the altered resource assignment is automatically created in accordance with the at least one assignment criteria.

In some embodiments, the data describing the one or more initially unassigned resources includes, for at least one of the one or more initially unassigned resources, an indication of a plurality of assignment criteria, and wherein the altered resource assignment is automatically created in accordance with a maximal number of the plurality of assignment criteria.

In some embodiments, the initial resource assignment is a rota for one or more employees; the one or more intervals are one or more intervals in the rota for which there is a shortage of employees; the data describing the one or more initially unassigned resources is data describing one or more available employees who indicated as part of a request for leave an availability to work additional shifts; and the altered resource assignment is an updated rota which assigns at least one of the one or more available employees to at least one of the one or more intervals.

In some embodiments, the computing device distributes the data describing the altered resource assignment to one or more other computing devices.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 is a flowchart of a computer implemented method for updating a first assignment of resources, according to some embodiments of the invention.

FIG. 3A is a flow diagram for generating data describing one or more auxiliary resources, according to embodiments of the invention;

FIGS. 3B and 3C show an example graphical user interface for requesting time off, according to some embodiments of the invention;

FIG. 4 shows a flow diagram for updating a first assignment of resources, according to some embodiments of the invention;

FIG. 5A shows an example first assignment of resources, according to some embodiments of the invention; and

FIG. 5B shows an example second assignment of resources, according to some embodiments of the invention.

It will be appreciated that for simplicity and clarity of illustration, elements shown in the FIGURES have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Embodiments of the invention relate generally to a novel method of updating a first assignment of resources, for example a schedule of one or more workers, using auxiliary resources, for example one or more workers who have indicated they are open to working extended hours/extra shifts.

As used herein, “Call Center” may refer to a centralized office used for receiving or transmitting a large volume of enquiries by telephone. An inbound call center may be operated by a company (e.g. a tenant) to administer incoming product or service support or information enquiries from consumers.

As used herein, “Contact Center” may refer to a call center which handles other types of communications other than voice telephone calls, for example, email, message chat, SMS, etc. Reference to call center should be taken to be applicable to contact center.

As used herein, an “Agent” may be a contact center worker that answers incoming contacts, handles customer requests and so on.

As used herein, “Work Force Management (WFM)” may refer to an integrated set of processes that a company uses to optimize the productivity of its employees. WFM involves effectively forecasting staffing requirements and creating and managing staff schedules to accomplish a particular task on a day-to-day and hour-to-hour basis.

As used herein, “Staffing Requirements” may refer to the required amount of personnel (e.g. agents) needed at a contact center to handle expected/forecasted contacts in accordance with quality-of-service metrics.

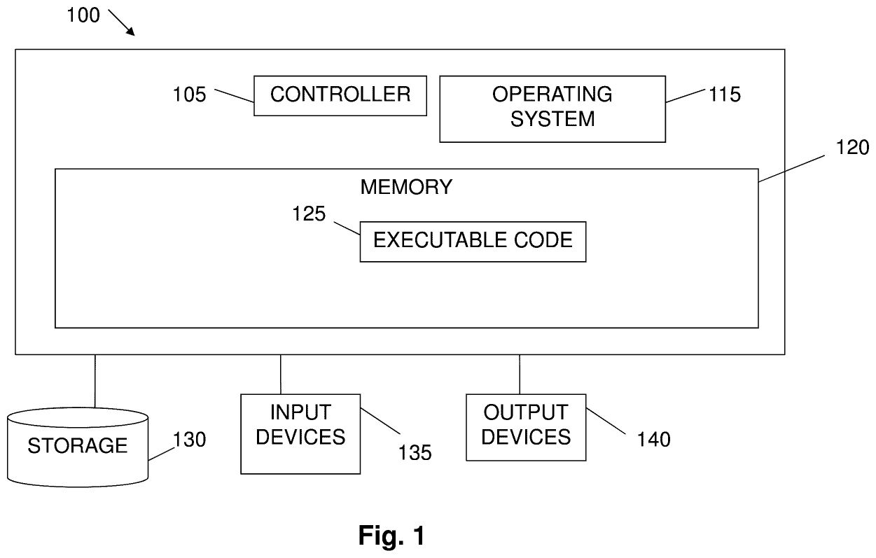

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out methods as disclosed herein, and/or data such as resource assignments (e.g. schedules), available resources (e.g. available agents), forecast data, or any other type of data.

Executable code 125 may be any application, program, process, task, or script. Executable code 125 may be executed by controller 105 possibly under control of operating system 115. For example, executable code 125 may be or execute one or more applications performing methods as disclosed herein, such as for updating an assignment of resources. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

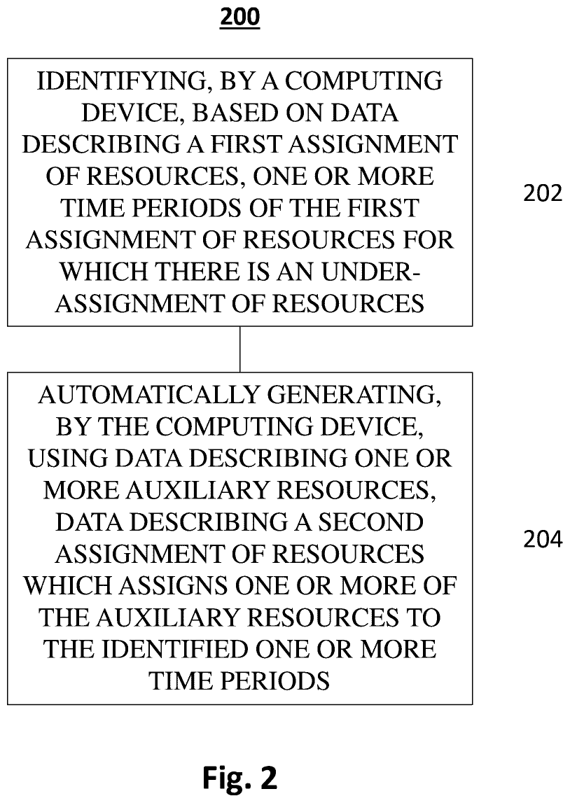

FIG. 2 shows a flowchart of a computer implemented method 200 for updating (e.g. altering) a first assignment of resources (e.g. an initial resource assignment), according to some embodiments of the invention.

Method 200 may include identifying, by a computing device, based on data describing a first assignment of resources, one or more time periods (e.g. intervals) of the first assignment of resources for which there is an under-assignment of resources (Step 202), such as a number of assigned resources that is less than a number of resources forecasted to be required for the one or more time periods/intervals. A forecasted number of required resources may be based on a predicted volume or workload expected to be received, for example predicted based on simulations or other models, potentially using historic data of workloads/volumes for previous time periods.

In some embodiments, an under-assignment of resources may be an under-assignment of computing resources. In such embodiments, an under-assignment may be indicated by a net resource parameter, for example a parameter which quantifies a difference between a required level of computing power (e.g. based on a forecasted workload for the time period) and a scheduled level of computing power. Computing power may be measured in total number of processors, performance per watt, LINPAK benchmark, floating point operations per second (FLOPS), or any other suitable measure. In some embodiments, one or more intervals of an initial resource assignment are determined for which a number of assigned resources is less than a number of resources forecasted to be required for the one or more intervals.

The computing device may be a computing device such as computing device 100 shown in FIG. 1.

The data describing the first assignment of resources may be data describing an assignment of computer processor, memory, and/or storage resources. The data describing the first assignment of resources may be data describing a number, and/or assignment of, virtual machines, a virtual machine being a virtualization/emulation of a computer system, as is known in the art. The data describing the first assignment of resources may be, for example, a schedule/rota for one or more agents, workers, or employees. The schedule may have been generated by a work force management (WFM) application. The schedule may be represented in a data format such as a JSON document (JavaScript Object Notation); other data formats may be used. In some embodiments, the data is received at the computing device. In some embodiments the data is retrieved from a storage and/or memory of the computing device, such as storage 130 and/or memory 120 of computing device 100 shown in FIG. 1.

The one or more time periods of the first assignment of resources for which there is an under-assignment of resources may be, for example, one or more schedule intervals for which there is an understaffing (e.g. a shortage of employees). In some embodiments, an understaffing is indicated by a net staffing parameter, for example a negative value of a net staffing parameter. The net staffing parameter may be a difference between a number of scheduled workers and a number of required workers, for example as determined by forecasts and staffing requirements. Different time periods of the schedule (e.g., 15 minute slots, 1 hour slots, etc.) may have different numbers of required workers and so may have different net staffing parameters. Embodiments of the invention may identify those time periods which have fewer scheduled workers than the number of required workers for that time period.

Method 200 may include automatically generating/creating, by the computing device, using data describing one or more auxiliary resources (e.g. initially unassigned resources), data describing a second assignment of resources (e.g. an altered resource assignment) which assigns one or more of the auxiliary resources to the identified one or more time periods (Step 204). For example, existing scheduling technologies, such as one or more algorithms, may be altered or updated with the data describing the auxiliary resources to generate resource assignments which use the available auxiliary resources to produce assignment combinations which balance the under-assignment.

The data describing one or more auxiliary resources may be, for example, data describing additional computing resources that can be used, for example if during a given processing job the performance of one or more computing resources degrades, additional computing resources can be used to stabilize performance and achieve the required output of the processing job. An embodiment includes using this data to redeploy, transfer or allocate resources. For example, data describing resources may be used by a computer system to automatically assign virtual machines, memory, or processing resources among different computer systems, or to generate schedules assigning people to work in different time slots, or to assign work via computer systems to workers at different times.

In some embodiments, the data describing one or more auxiliary resources is data describing one or more available workers/employees who indicated as part of a time-off request (e.g. request for leave) an availability outside of a predefined set of work times (e.g. an availability to work additional shifts). The second assignment of resources may be, for example, an updated schedule which assigns at least one of the one or more available workers to at least one of the one or more time periods.

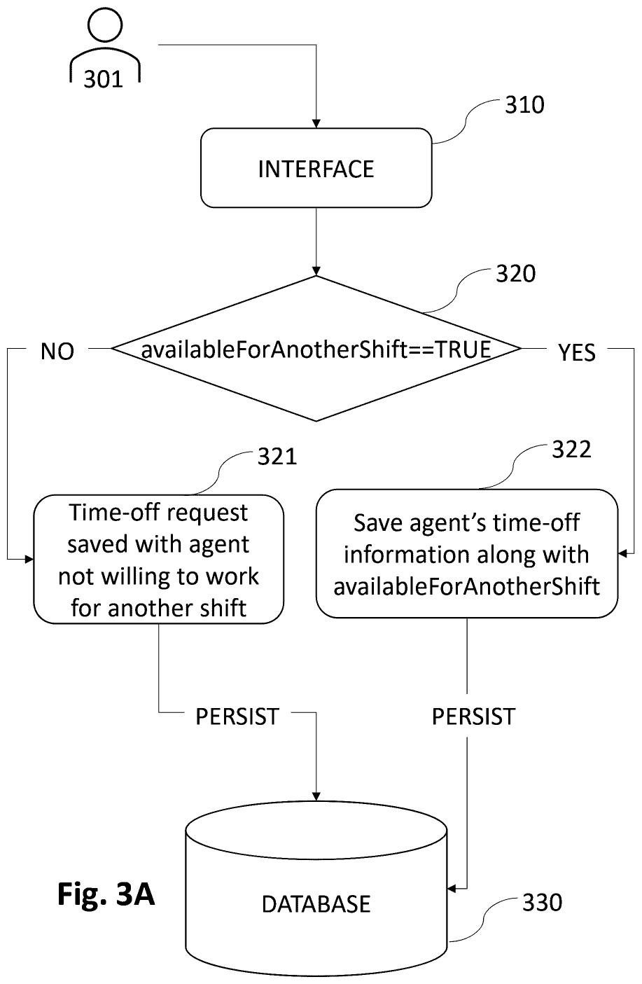

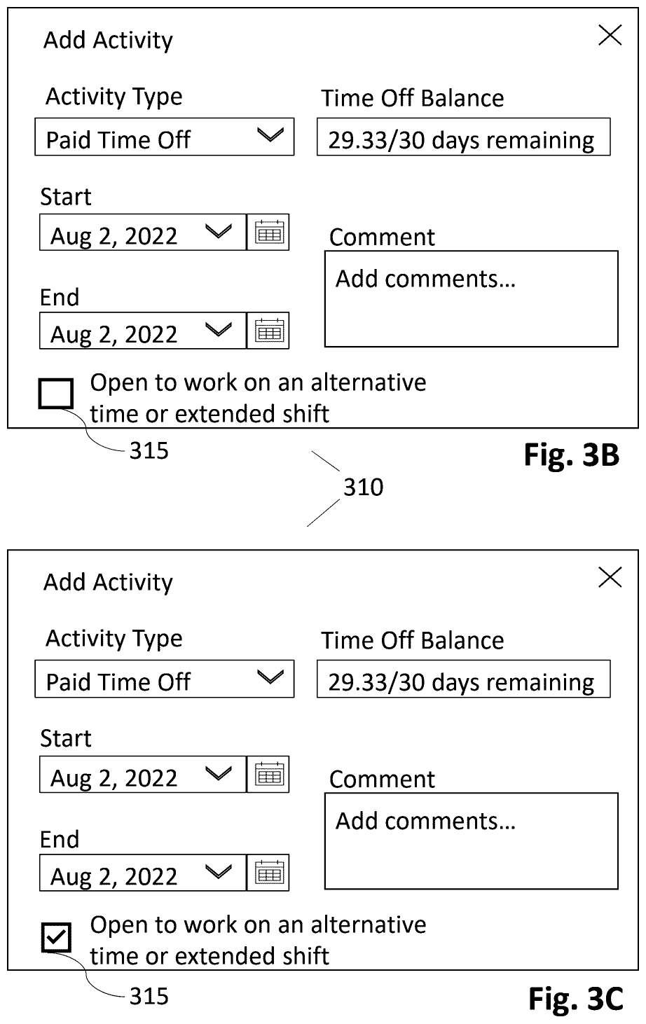

In some embodiments, the data describing the one or more auxiliary resources includes an indication of an availability of the one or more auxiliary resources for the identified one or more time periods. The indication may have been made using a graphical user interface, such as described with respect to FIGS. 3B and 3C. In some embodiments, the data is received at the computing device. In some embodiments the data is retrieved from a storage and/or memory of the computing device, such as storage 130 and/or memory 120 of computing device 100 shown in FIG. 1.

In some embodiments, the data describing the one or more auxiliary resources includes, for at least one of the one or more auxiliary resources, an indication of at least one assignment rule/criteria. The second assignment of resources may be automatically generated in accordance with the at least one assignment rule/criteria. For example, an assignment rule for a particular worker may be that the worker is not to be scheduled for work on Fridays (for example because the worker observes the Jewish Shabbat). The second assignment of resources (e.g. updated schedule) may be automatically generated by the computing device taking this rule into account and avoid assigning/scheduling said worker to an understaffed time period on a Friday. Assignment rules may also govern a time and/or duration of break times, such as due to lunch, contractual agreements, and/or employment laws. For example, a daily rule may be a rule defined by a supervisor which governs activities/times/durations for an employee for a given day. For example, a supervisor may want agents to work from 7:00 am to 4:00 pm, with a 15 minute break starting at 11:00 and 30 minute lunch starting at 2 pm. There may be a plurality of daily rules created based on a contact center's requirements. Weekly rules may combine one or more daily rules and map them to the days of the week the rule should be applicable to. Existing scheduling technologies may use assignment rules to create the first/initial schedule, and embodiments of the invention may alter/update the schedules for periods where understaffing is detected, such as by using those workers who indicated that they were available to work alternative shifts. For example, a number of different scheduling rules may be configured such as daily rules, weekly rules, agent availability rules, skills-based rules (e.g. for different agent skills such as accounting, customer complaints, etc.) and scheduling unit (SU) hours of operation, which may be used by one or more algorithms to generate a number of allowable combinations. One or more other algorithms may use input as to the contact center's requirements to select optimal schedule combinations which balance out the day. However, as described, where multiple workers take time off, this reduces the available scheduling combinations and can result in understaffing. The present invention makes use of at least some of these absent workers to define temporary rules which allow new balanced schedules to be generated.

The data describing the one or more auxiliary resources may include, for at least one of the one or more auxiliary resources, an indication of a plurality of assignment rules/criteria, and the second assignment of resources may be automatically generated in accordance with a maximal number of the plurality of assignment rules/criteria. For example, the second assignment of resources (e.g. updated schedule) may be automatically generated by the computing device such that as many assignment rules as possible are respected. Some assignment rules may be broken if necessary to generate an updated schedule. A user, such as a supervisor/manager, may predefine a required number and/or priority of rules to be taken into account by the computing device when automatically generating the second assignment of resources.

In some embodiments, method 200 may include distributing, e.g. by the computing device, the data describing the second assignment of resources to one or more other computing devices. The second assignment of resources may be distributed automatically. In some embodiments, the second assignment of resources may be approved by a manager prior to being distributed.

As discussed, method 200 may be applicable for WFM uses. For example, the first assignment of resources may be a schedule for one or more workers; the one or more time periods may be one or more time periods in the schedule for which there is an understaffing; the data describing the one or more auxiliary resources may be data describing one or more available workers who indicated as part of a time-off request an availability outside of a predefined set of work times; and the second assignment of resources may be an updated schedule which assigns at least one of the one or more available workers to at least one of the one or more time periods.

For example, when requesting time off/leave, a worker may be presented with the option of consenting/indicating that they are willing to work on an alternative day and/or extended time (e.g. alternative/additional shift) against their time off duration for a given day. For example, if a worker requests a full day off, the worker can indicate they are willing to work on a different day, and if a worker requests a partial day off (e.g. some portion of a working day) they can indicate that they are willing to work extended hours which can compensate their lost hours due to partial time-off for that day.

A checkbox or other data submission means may be presented to a worker as part of a user interface when requesting a time off for the worker to indicate their willingness/availability for alternative work times. For example, a checkbox alongside the statement “Open to work on an alternative time or extended shift” or other equivalent phrasing may be presented to a worker as part of the process of requesting time off. Checking the box may constitute an indication that the worker is available for one or more time periods for which there is an identified under-assignment/shortage/understaffing. The worker's response may be recorded in a data format for use by the computing device executing one or more method steps. For example, a Boolean value for an “availableForAnotherShift” parameter may be used. Other data implementations/representations may be used.

FIG. 3A shows a flow diagram for generating data describing one or more auxiliary resources, according to embodiments of the invention. Data describing one or more auxiliary resources may include, for example, a list or database (such as a directory service of network addresses) describing one or more available computing resources. Generating data describing one or more auxiliary resources may include, for example, generating data describing one or more available workers who indicated as part of a time-off request an availability outside of a predefined set of work times. For example, a worker/agent 301 may use an interface 310 (e.g., a graphical user interface (GUI)) to request a time off. Interface 310 may be executed by and/or displayed on a computing device such as computing device 100 shown in FIG. 1. Interface 310 may be part of a desktop application, web application or other platform for requesting time off.

FIGS. 3B and 3C show an example graphical user interface (GUI) 310 for requesting resource alterations (in this specific example time off), according to some embodiments of the invention. Interface 310 may allow a worker/agent to request a time off, for example by selecting from a list of activity types. An activity type may be, for example, paid time off (e.g., holiday), unpaid time off, sickness, compassionate leave, study leave, or any other type of activity. Interface 310 may display to the worker/agent a number of days remaining for allowed time off. The worker/agent may be able to enter a start and end time/date for the activity. The worker/agent may be able to leave a comment associated with the time off request. Interface 310 may include a check box 315 for the worker/agent to check if they are open to work an alternative time or extended shift. Other data submission means may be used, such as a toggle switch.

In some embodiments, a willingness/openness to work an alternative time or extended shift may be assumed (e.g. may be a default) for time off requests. An opt-out option may be presented during the submission of a time off request, for example a checkbox associated with a statement such as “not open to work an alternative time or extended shift”.

Returning to FIG. 3A, worker/agent 301 may indicate an availability outside of a predefined set of work times as part of a time off request, for example by checking a graphical element displayed as part of interface 310 (for example check box 315). This indication may be converted, for example by a computing device 100 executing interface 310, into an availableForAnotherShift parameter.

A decision process 320 may be taken, for example by computing device 100, to determine if availableForAnotherShift evaluates to True. If the decision process at 320 is NO, the time off request may be saved as an ordinary time off request (321) with the worker/agent not willing to work a different shift. Data describing the time off request may be persisted in a database 330. If the decision process at 320 is YES, then the worker/agent's time off information may be saved (322) along with the availableForAnotherShift indicating their availability to work a different shift. Data describing the time off request and availableForAnotherShift may be persisted in database 330.

Embodiments of the invention may be referred to as an understaffing detector and schedule adjustor (UDSA) algorithm/system. In some embodiments, after an initial allocation of resources is created, e.g., after one or more schedules are generated, the UDSA may perform one or more of the following steps represented by the pseudo code of Table 1.

```
TABLE 1
1. Fetch the required number of agents from STAFFING_DATA & scheduled agents data from
SHIFT & ACTIVITY_INTERVAL tables
2. Calculate the net staffing using formula NET_STAFFING = SCHEDULED_AGENTS −
REQUIRED_AGENTS
3. If NET_STAFFING is greater than or equal to 0, then no action is required as the contact
center is either overstaffed or balanced
4. If NET_STAFFING is less than 0 then this means the contact center is understaffed. Gather
understaffing information for all the slots and save it in memory (List<UnderstaffedIntervals>)
5. Fetch the list of agents where availableForAnotherShift was set to TRUE from
TIME_OFF_REQUEST table
6. For the agents from Step 5, fetch their existing scheduling (weekly/daily) rules
7. If the existing scheduling rules match the understaffed intervals from
List<UnderstaffedIntervals> then utilize the scheduling rules to these intervals and generate
schedules for those agents
8. If the existing scheduling rules do not fall under the understaffed interval from
List<UnderstaffedIntervals> then
  8.1 Fetch the agent's scheduling unit from SCHEDULING_UNIT table
  8.2 Fetch all the agents from AGENT table belonging to scheduling unit from step
  8.1
  8.3 Fetch all the scheduling rules of those agents from WEEKLY_RULE &
  DAILY_RULE table
  8.4 If scheduling rules of other agents do not fall under the understaffed slots then
  no action required since we do not want the agents to work during those slots which
  do not align with the scheduling rules for the given Scheduling Unit.
9. If the existing scheduling rules fall under the understaffed intervals from
List<UnderstaffedIntervals> then
  9.1 create on-demand scheduling rules per agent and store it in memory as a
  temporary data structure Map<AGENT,SCHEDULING_RULE>
  9.2 Utilize these scheduling rules to generate schedules for understaffed slots and
  store those in SHIFT & ACTIVITY_INTERVAL table
```

The lists and tables referred to in Table 1, such as the SHIFT & ACTIVITY_INTERVAL tables, may be tables/lists of data stored in a database, such as storage 130 of computing device 100 shown in FIG. 1. It will be apparent to a person skilled in the art that other data representations may be used, and that different identifying names for sets of data may be used, as required.

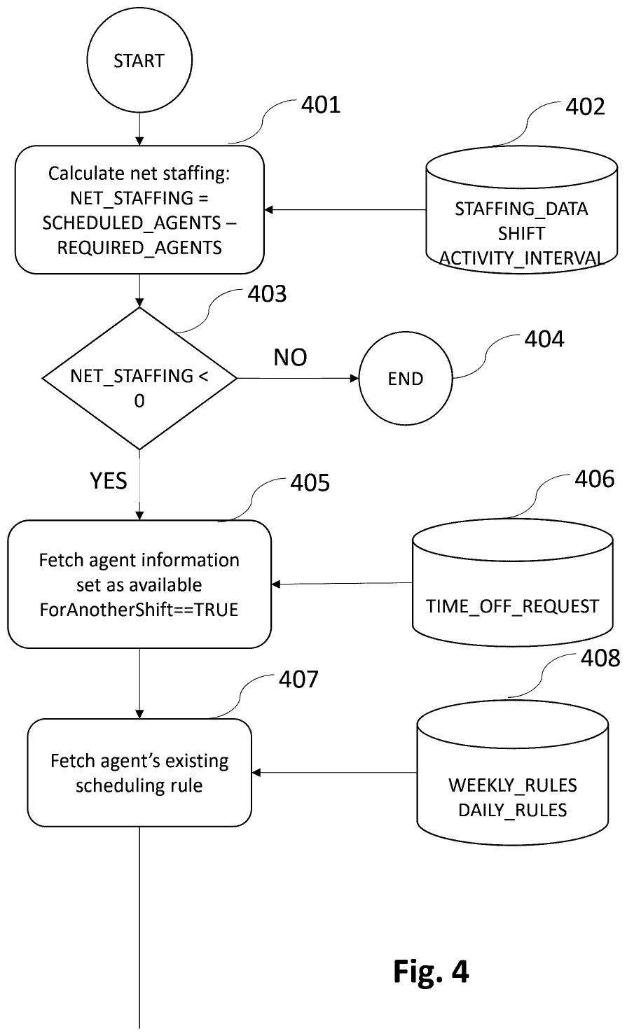

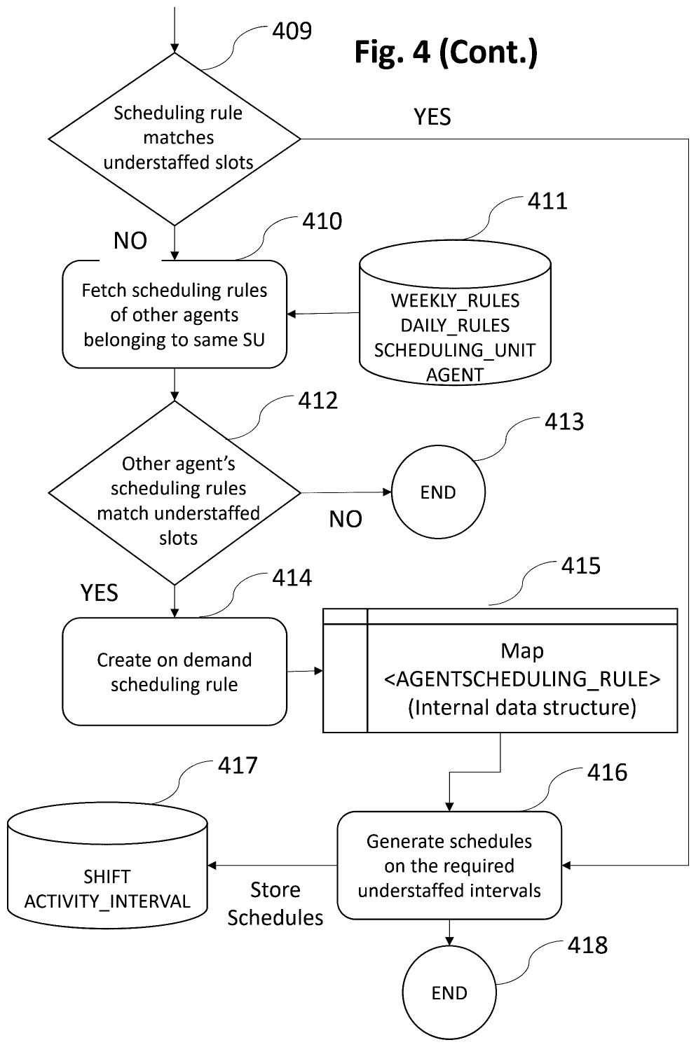

FIG. 4 shows a flow diagram for updating a first assignment of resources, according to some embodiments of the invention. The steps of FIG. 4 correspond in part to the pseudocode of Table 1, and may be executed by a computing device such as computing device 100 shown in FIG. 1.

For example, computing device 100 may calculate a net staffing (401). A net staffing may be calculated using staffing data, shift data and/or activity interval data (402), which may be retrieved from a database (such as storage 130). Net staffing may be calculated as NET_STAFFING=SCHEDULED_AGENTS−REQUIRED_AGENTS. Other formulas may be used.

Computing device 100 may determine (403) if the net staffing is less than zero. If the net staffing is not less than zero, e.g., there are as many or more scheduled agents than required agents, the process may end (404) because there is no schedule understaffing which needs to be resolved by a schedule update.

If the net staffing is less than zero, computing device 100 may fetch agent information for those agents where availableForAnotherShift==TRUE (405). Data describing time off requests (406), for example saved using the flow of FIG. 3, may be used which may be retrieved from a database (such as storage 130). The set of available agents corresponds to data describing one or more auxiliary resources.

Computing device 100 may fetch (407) existing scheduling rules of the one or more agents. Scheduling rules may be weekly rules and/or daily rules (408) retrieved from a database.

Computing device 100 may determine (409) if a scheduling rule matches the understaffed slots, e.g., those time periods for which the net staffing is less than zero. If no, and the scheduling rule does not match the understaffed slots, the computing device may fetch (410) scheduling rules of other agents belonging to same scheduling unit (SU). A scheduling unit may be a group of agents which work in the same department and/or share similar schedules, work times, and/or scheduling rules. Computing device 100 may use data describing weekly rules, daily rules, scheduling units and/or agents (411), which may be retrieved from a database (such as storage 130).

Computing device 100 may determine (412) if the other agents' scheduling rules match the understaffed slots. If not, the process may end (413). If yes, the computing device may create (414) an on demand scheduling rule for the agent.

The computing device may map (415) in an internal data structure a new agent scheduling rule for the agent.

Computing device 100 may generate (416), for example automatically generate, one or more schedules for the required understaffed intervals. The generated schedule(s) may be stored (417) in a database. The process may then end (418).

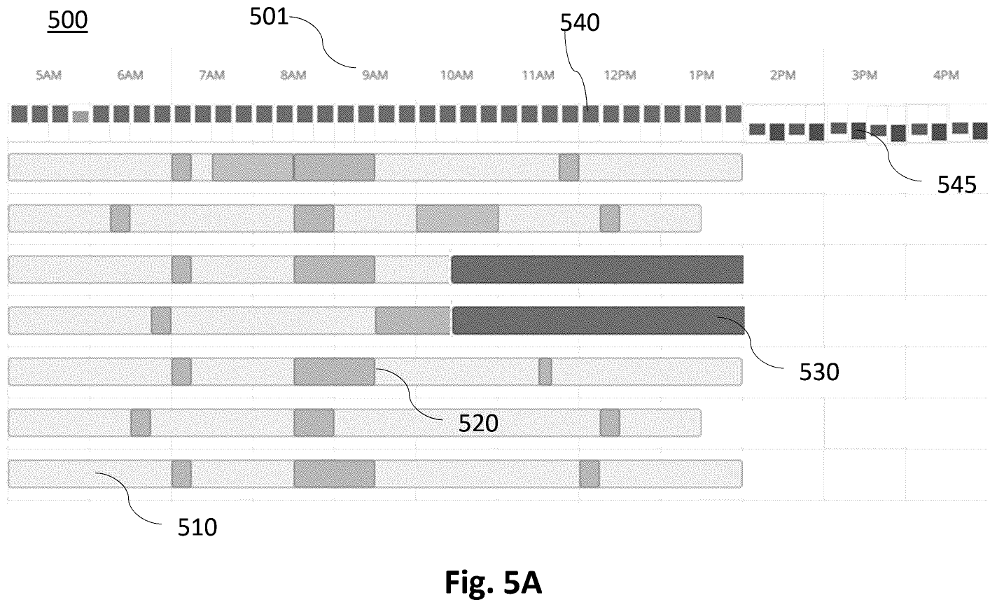

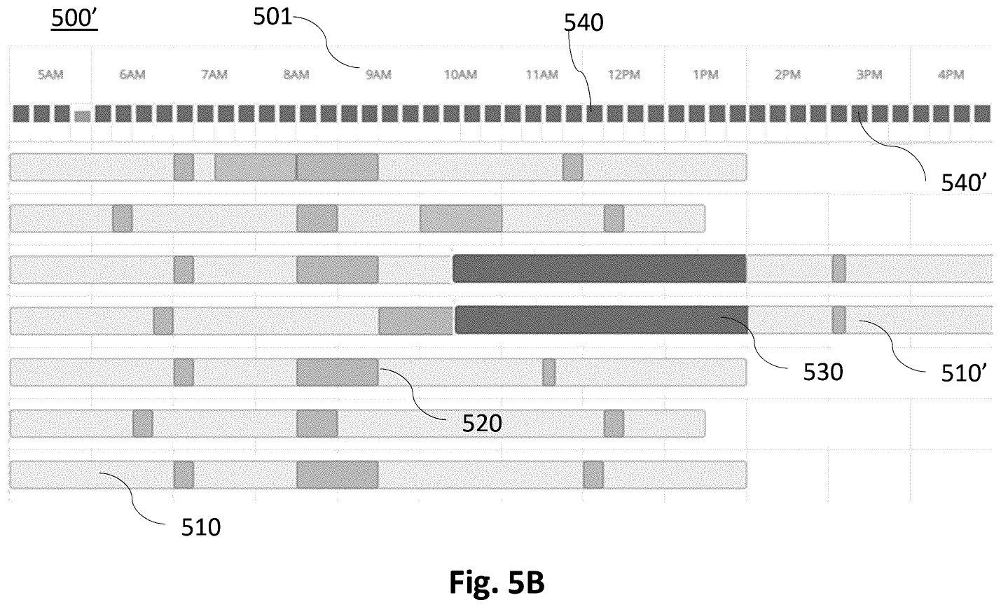

FIG. 5A shows an example first assignment of resources 500, according to some embodiments of the invention. Resource assignment 500 may be a schedule for one or more workers/agents. The resource assignment 500 may be a schedule for one or more computing resources. Resource assignment 500 may be represented as data in machine readable format, such as a JavaScript Object Notation (JSON) document; other data formats may be used.

Resource assignment 500 may include one or more time periods 501, such as hour intervals. Resource assignment 500 may include one or more different activity types, for example active periods 510, inactive periods 520 (such as scheduled breaks for workers, or scheduled maintenance for computing resources) and time off 530.

Resource assignment 500 may include data 540, 545 describing a net assignment of resources. For example, data 540 may indicate that for a time period 501 there is a sufficient assignment of resources (e.g., as determined by a net staffing parameter). Data 545 may indicate that there is an under-assignment of resources for one or more time periods, for example one or more time periods in the schedule for which there is an understaffing (e.g., as determined by a net staffing parameter). Data 540 and/or 545 describing sufficient/under assignment of resources may describe time periods shorter than time period 501. For example, as shown in FIG. 5A, time periods 501 of 1 hour have data 540/545 describing 15 minute intervals of time period 501 (e.g. four per hour).

FIG. 5B shows an example second assignment of resources 500′, according to some embodiments of the invention. For example, resource assignment 500′ may be an updated schedule (e.g. update of schedule 500) for the one or more workers/agents. Second assignment 500′ may be automatically generated by embodiments of the invention following identifying (e.g. by a computing device such as computing device 100 of FIG. 1), based on data 545, one or more time periods of the first resource assignment 500 for which there is an under-assignment of resources. Data describing one or more auxiliary resources, such as generated as described with respect to FIG. 3A may be used to identify one or more available workers who indicated as part of a time-off request an availability outside of a predefined set of work times. Resource assignment 500′ may be automatically generated using the data describing the one or more auxiliary resources such that the one or more of the auxiliary resources are assigned to the identified one or more time periods. For example, as seen in second assignment 500′, for the workers with time off 530 (who indicated as part of their time off request that they were available for extended shifts) their schedule has been extended (510′) by embodiments of the invention, thus solving (540′) the understaffing (545) present in the first assignment 500. The updated schedule 500′ may be distributed to workers following approval by a manger. In some embodiments, an updated schedule may be automatically distributed without the need for human approval.

Embodiments of the invention may be used alongside pre-existing resource assignment programs, for example pre-existing schedule generation programs such as the WFM schedule manager application offered by NICE Ltd.

For example, embodiments of the invention may be used alongside a scheduling system. A scheduling system may include a schedule manager microservice (MS). The schedule manager microservice may be an application as part of the scheduling system. The schedule manager microservice may store and retrieve schedule data, net staffing data, and any other configurations such as daily rules, weekly rules, and/or activity codes required to generate schedules.

The scheduling system may include a scheduler MS. The scheduler MS may be responsible for handling scheduling generation jobs. This may include extracting and packaging all data required for a schedule generation, submitting jobs to a cloud computing service such as Amazon Web Services (AWS) Batch, updating job statuses, and saving scheduling results and/or forecast requirement data to the schedule manager MS.

The scheduling system may include a batch service. A batch service may run a spart of a cloud computing service, for example AWS batch. The batch service may run a scheduler library and may execute schedule generation. The batch service may take a “problem file” from an object storage bucket, such as S3 (Amazon Simple Storage Service), as input, and may write a “solution file” to another object storage bucket as an output. One or more triggers may be setup on these buckets that notify the scheduler MS when files are written to the input or output buckets.

The scheduling system may include a schedule requests manager service. The schedule requests manager service may allow agents to request changes to their own schedules, and to allow for approvals and approval processes on requests. These requests may include time off and rescheduling. Once requests are approved, the schedule requests manager may make calls (e.g., application programming interface (API) calls) to the schedule manager MS to persist scheduling changes. Shift trades and shift bidding may be handled by the schedule manager MS and a shift bidding manager service respectively.

The present invention may be embodied as a system, for example as a system for updating a first assignment of resources, the system including a computing device (such as computing device 100 of FIG. 1) which includes at least one processor and a memory containing instructions which, when executed by the at least one processor, cause the at least one processor to: identify, based on data describing a first assignment of resources, one or more time periods of the first assignment of resources for which there is an under-assignment of resources; and automatically generate, using data describing one or more auxiliary resources, data describing a second assignment of resources which assigns one or more of the auxiliary resources to the identified one or more time periods.

The present invention may be embodied as a non-transitory computer readable storage medium containing instructions which, when executed by at least one processor in a computing device (such as computing device 100 of FIG. 1), cause the at least one processor to carry out methods as described herein.

Embodiments of the invention may improve existing scheduling technologies by rapidly and automatically adjusting schedules using previously unutilized resources. For example, data describing one or more auxiliary resources (such as workers who indicated as part of a time-off request an availability outside of a predefined set of work times) may be used to solve an under-assignment of resources.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A computer implemented method of updating a first assignment of resources, the method comprising:
identifying, by a computing device, based on data describing a first assignment of resources, one or more time periods of the first assignment of resources for which there is an under-assignment of resources; and
automatically generating, by the computing device, using data describing one or more auxiliary resources, data describing a second assignment of resources which assigns one or more of the auxiliary resources to the identified one or more time periods.

2. The method of claim 1, wherein the data describing the one or more auxiliary resources comprises an indication of an availability of the one or more auxiliary resources for the identified one or more time periods.

3. The method of claim 1, wherein the data describing the one or more auxiliary resources comprises, for at least one of the one or more auxiliary resources, an indication of at least one assignment rule, and wherein the second assignment of resources is automatically generated in accordance with the at least one assignment rule.

4. The method of claim 1, wherein the data describing one or more auxiliary resources comprises, for at least one of the one or more auxiliary resources, an indication of a plurality of assignment rules, and wherein the second assignment of resources is automatically generated in accordance with a maximal number of the plurality of assignment rules.

5. The method of claim 1, wherein:
the first assignment of resources is a schedule for one or more workers;
the one or more time periods are one or more time periods in the schedule for which there is an understaffing;
the data describing the one or more auxiliary resources is data describing one or more available workers who indicated as part of a time-off request an availability outside of a predefined set of work times; and
the second assignment of resources is an updated schedule which assigns at least one of the one or more available workers to at least one of the one or more time periods.

6. The method of claim 5, wherein the availability outside of the predefined set of work times of the one or more available workers is indicated using a graphical user interface associated with an application platform for requesting time off.

7. The method of claim 1, comprising distributing, by the computing device, the data describing the second assignment of resources to one or more other computing devices.

8. A system for updating a first assignment of resources, the system comprising:
a computing device comprising at least one processor and a memory containing instructions which, when executed by the at least one processor, cause the at least one processor to:
identify, based on data describing a first assignment of resources, one or more time periods of the first assignment of resources for which there is an under-assignment of resources; and
automatically generate, using data describing one or more auxiliary resources, data describing a second assignment of resources which assigns one or more of the auxiliary resources to the identified one or more time periods.

9. The system of claim 8, wherein the data describing the one or more auxiliary resources comprises an indication of an availability of the one or more auxiliary resources for the identified one or more time periods.

10. The system of claim 8, wherein the data describing the one or more auxiliary resources comprises, for at least one of the one or more auxiliary resources, an indication of at least one assignment rule, and wherein the second assignment of resources is automatically generated in accordance with the at least one assignment rule.

11. The system of claim 8, wherein the data describing one or more auxiliary resources comprises, for at least one of the one or more auxiliary resources, an indication of a plurality of assignment rules, and wherein the second assignment of resources is automatically generated in accordance with a maximal number of the plurality of assignment rules.

12. The system of claim 8, wherein:
the first assignment of resources is a schedule for one or more workers;
the one or more time periods are one or more time periods in the schedule for which there is an understaffing;
the data describing the one or more auxiliary resources is data describing one or more available workers who indicated as part of a time-off request an availability outside of a predefined set of work times; and
the second assignment of resources is an updated schedule which assigns at least one of the one or more available workers to at least one of the one or more time periods.

13. The system of claim 12, wherein the availability outside of the predefined set of work times of the one or more available workers is indicated using a graphical user interface associated with an application platform for requesting time off.

14. The system of claim 8, wherein the at least one processor is configured to distribute the data describing the second assignment of resources to one or more other computing devices.

15. A computer implemented method for altering an initial resource assignment, the method comprising:
determining, by a computing device, from data describing the initial resource assignment, one or more intervals of the initial resource assignment for which a number of assigned resources is less than a number of resources forecasted to be required for the one or more intervals; and
automatically creating, by the computing device, using data describing one or more initially unassigned resources, data describing an altered resource assignment which assigns one or more of the initially unassigned resources to the identified one or more intervals.

16. The method of claim 15, wherein the data describing the one or more initially unassigned resources comprises an indication of an availability of the one or more initially unassigned resources for the identified one or more intervals.

17. The method of claim 15, wherein the data describing the one or more initially unassigned resources comprises, for at least one of the one or more initially unassigned resources, an indication of at least one assignment criteria, and wherein the altered resource assignment is automatically created in accordance with the at least one assignment criteria.

18. The method of claim 15, wherein the data describing the one or more initially unassigned resources comprises, for at least one of the one or more initially unassigned resources, an indication of a plurality of assignment criteria, and wherein the altered resource assignment is automatically created in accordance with a maximal number of the plurality of assignment criteria.

19. The method of claim 15, wherein:
the initial resource assignment is a rota for one or more employees;
the one or more intervals are one or more intervals in the rota for which there is a shortage of employees;
the data describing the one or more initially unassigned resources is data describing one or more available employees who indicated as part of a request for leave an availability to work additional shifts; and
the altered resource assignment is an updated rota which assigns at least one of the one or more available employees to at least one of the one or more intervals.

20. The method of claim 15, wherein the computing device distributes the data describing the altered resource assignment to one or more other computing devices.
